(19) United States
(12) Patent Application Publication
(10) Pub. No.: US 2006/0265362 A1
(43) Pub. Date: Nov. 23, 2006

(54) Federated queries and combined text and relational data

(75) Inventor: Roger Burrowes Bradford, Great Falls, VA (US)

Correspondence Address: STERNE, KESSLER, GOLDSTEIN & FOX PLLC, 1100 NEW YORK AVENUE, N.W., WASHINGTON, DC, 20005, US

(73) Assignee: Content Analyst Company, LLC, Reston, VA (US)

(21) Appl. No.: 11/434,749

(22) Filed: May 17, 2006

Related U.S. Application Data
(60) Provisional application No. 60/681,943, filed on May 18, 2005.

(51) Int. Cl. G06F 17/30

(52) U.S. Cl. 707/3

(57) ABSTRACT

A method for ranking data-objects retrieved from a plurality of databases is provided. First, data-objects are retrieved from a plurality of databases, wherein each database is accessed using a retrieval product. Second, a representation of each of the data-objects retrieved from the plurality of databases is generated in a conceptual representation space. Third, a representation of a query is generated in the conceptual representation space. Then, the data-objects are ranked with respect to the query based on a similarity between the representation of each data-object and the representation of the query.

### CROSS REFERENCE TO RELATED APPLICATIONS

This application claims benefit under 35 U.S.C. § 119(e) to U.S. Provisional Patent Application 60/681,943, entitled “Federated Queries and Combined Text and Relational Data,” to Bradford, filed on May 18, 2005, the entirety of which is incorporated by reference herein.

### BACKGROUND OF THE INVENTION

1. Field of the Invention

The present invention pertains generally to federated queries, and more particularly to ranking results from federated queries.

2. Background Art

Even for a given type of data, many organizations have multiple databases, often indexed by differing information retrieval products. Interfaces to the various products typically allow a single query to be applied to multiple databases, which is often referred to as employing a federated query. However, the different retrieval products often apply different models to the data. This makes it difficult to combine the results in a fashion that makes sense to a user. For example, in response to a given query, text retrieval systems typically return a ranked list of documents. Within that list, the higher the rank of a document, the more that system judges that document to be relevant to the user's query.

However, different approaches to relevance ranking may be employed by different information retrieval products. Often, only the relative ranking is made available to the user. Even when some measure of query-document similarity is provided, these measures may vary from information retrieval product to information retrieval product. There also is a problem stemming from the fact that the collections of data indexed by the different information retrieval products may vary in terms of the relevance of the documents that they contain. In such a case, the top-ranked document from one text database might be substantially less relevant to the user's query than one ranked well down in the ordering from another database. For products that only provide a relative ranking, this presents a problem even for results from two copies of the same retrieval product that have been used to index two different text collections.

Current approaches for interleaving results from multiple search operations are generally simplistic. Some use a round-robin approach, where all of the top-most ranked documents are ranked highest, then all of the second-most-highly ranked documents, etc. When measures of query-document similarities are provided by the individual engines, these are usually normalized for combination. That is, the highest and lowest scores are mapped to an arbitrary range, such as 0 to 1. The individual scores are mapped into this range and then directly combined. These approaches have not worked particularly well in applications.

Given the foregoing, what is needed is an improved method and system for ranking results retrieved from a federated query. Such a method and system should be independent of the individual ranking models employed by the various retrieval products. In addition, such a method and system should automatically compensate for diversity in the relevance of the results retrieved from the different text collections. Moreover, such a method and system should be language independent. And, such a method and system should be extendable to data-objects other than just text data.

### BRIEF SUMMARY OF THE INVENTION

According to embodiments of the present invention there is provided a method and system for ranking the results of a federated query. The results are ranked based on a similarity measure defined in a conceptual representation space.

According to an embodiment of the present invention there is provided a method for ranking data-objects retrieved from a plurality of databases. First, data-objects are retrieved from a plurality of databases, wherein each database is accessed using a retrieval product. Second, a representation of each of the data-objects retrieved from the plurality of databases is generated in a conceptual representation space. Third, a representation of a query is generated in the conceptual representation space. Then, the data-objects are ranked with respect to the query based on a similarity between the representation of each data-object and the representation of the query.

According to another embodiment of the present invention there is provided a method for ranking data-objects retrieved from a plurality of databases. The method includes the followings steps. First, a conceptual representation space is generated based on a first plurality of data-objects and a second plurality of data-objects, wherein the first plurality of data-objects comprises data-objects of a first data type and the second plurality of data-objects comprises data-objects of a second data type, and wherein each data-object in the first plurality of data-objects corresponds to a data-object in the second plurality of data-objects. Second, a third plurality of data-objects is retrieved. Each data-object in the third plurality of data-objects is either a data-object of the first data type or a data-object of the second data type. Third, a representation of each data-object in the third plurality of data-objects is generated in the conceptual representation space. Fourth, a representation of a query is generated in the conceptual representation space. Then, the data-objects in the third plurality of data-objects are ranked with respect to the query based on a similarity between the representation of the query and the representation of each data-object in the third plurality of data-objects.

According to a further embodiment of the present invention there is provided a computer program product for ranking data-objects retrieved from a plurality of databases. The computer program product comprises a computer usable medium having computer readable program code stored therein that causes an application program to execute on an operating system of a computer. The computer readable program code includes computer readable first, second, third, and fourth program code. The computer readable first program code causes the computer to retrieve data-objects from a plurality of databases, wherein each database is accessed using a retrieval product. The computer readable second program code causes the computer to generate a representation of each of the data-objects retrieved from the plurality of databases in a conceptual representation space. The computer readable third program code causes the computer to generate a representation of a query in the conceptual representation space. The computer readable fourth program code causes the computer to rank the data-objects with respect to the query based on a similarity between the representation of each data-object and the representation of the query.

According to a still further embodiment of the present invention there is provided a computer program product for ranking data-objects retrieved from a plurality of databases. The computer program product comprises a computer usable medium having computer readable program code stored therein that causes an application program to execute on an operating system of a computer. The computer readable program code includes computer readable first, second, third, fourth, and fifth program code. The computer readable first program code causes the computer to generate a conceptual representation space based on a first plurality of data-objects and a second plurality of data-objects, wherein the first plurality of data-objects comprises data-objects of a first data type and the second plurality of data-objects comprises data-objects of a second data type, and wherein each data-object in the first plurality of data-objects corresponds to a data-object in the second plurality of data-objects. The computer readable second program code causes the computer to retrieve a third plurality of data-objects. Each data-object in the third plurality of data-objects is a data-object of the first data type or a data-object of the second data type. The computer readable third program code causes the computer to generate a representation of each data-object in the third plurality of data-objects in the conceptual representation space. The computer readable fourth program code causes the computer to generate a representation of a query in the conceptual representation space. The computer readable fifth program code causes the computer to rank the data-objects in the third plurality of data-objects with respect to the query based on a similarity between the representation of the query and the representation of each data-object in the third plurality of data-objects.

Embodiments of the present invention provide several example advantages. First, an example method in accordance with an embodiment of the present invention can be applied to results from any text retrieval system, independent of the individual ranking models employed. For example, it can be applied to result sets that do not provide any similarity metric, but simply a relative ranking. Second, an example method in accordance with an embodiment of the present invention automatically compensates for the fact that there may be diversity in the relevance of documents in the multiple databases. Third, an example method in accordance with an embodiment of the present invention is independent of language and may even be applied in a multilingual environment (by employing cross-lingual processing, as described, e.g., in U.S. Pat. No. 5,301,109 (“the '109 patent”), the entirety of which is incorporated by reference herein). Fourth, an example method in accordance with an embodiment of the present invention can be extended to encompass ranking of results in multimedia databases.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a system diagram in which a method for ranking federated queries may be implemented in accordance with an embodiment of the present invention.

FIG. 2 depicts a flowchart of a method for ranking data objects (e.g., documents) retrieved from multiple databases with respect to a query in accordance with an embodiment of the present.

FIG. 3 depicts a flowchart of a method for ranking data-objects of a known type with respect to a query in accordance with an embodiment of the present invention.

FIG. 4 is a block diagram of a computer system on which an embodiment of the present invention may be executed.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is typically indicated by the leftmost digit(s) in the corresponding reference number.

### DETAILED DESCRIPTION OF THE INVENTION

### I. Overview

An embodiment of the present invention allows results from a federated query to be ranked in a single unified manner. The results are represented in a conceptual representation space, and then ranked based on a metric defined in the conceptual representation space.

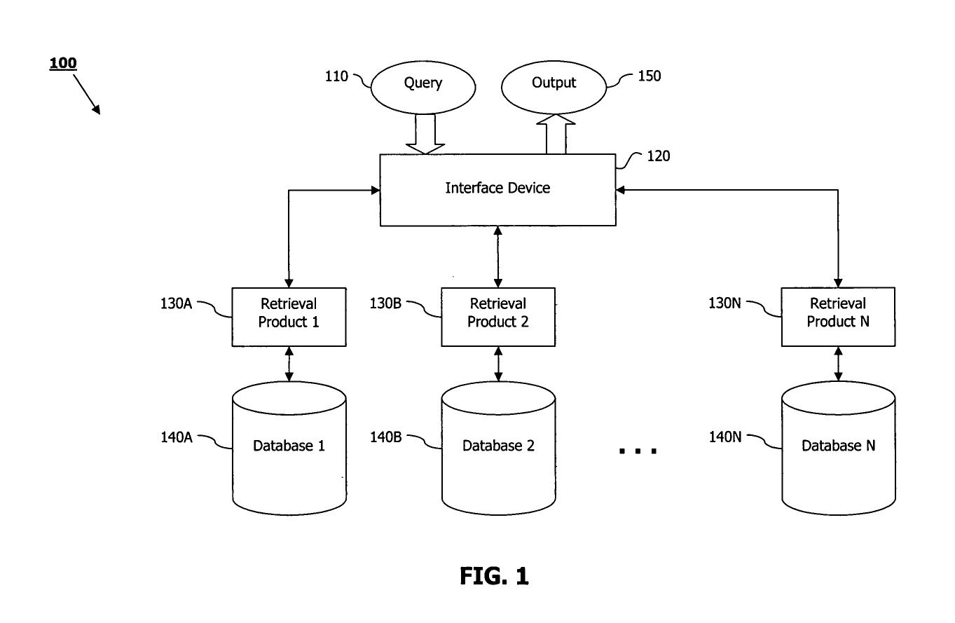

FIG. 1 illustrates a system 100 in which an example method for ranking results from a federated query may be implemented in accordance with an embodiment of the present invention. System 100 includes an interface device 120 (such as a PC or some other similar type of interface device), which is coupled to a plurality of retrieval products, including a first retrieval product 130A, a second retrieval product 130B, and so on up to and including an Nth retrieval product 130N (wherein N is an integer that is greater than or equal to 2). Retrieval products 130 may be any retrieval product as are well-known by persons skilled in the relevant art(s). First retrieval product 130A is coupled to a first database 140A, second retrieval product 130B is coupled to a second database 140B, and Nth retrieval product 130N is coupled to an Nth database 140N. In other words, each of the plurality of retrieval products 130 is coupled to one database in the plurality of databases 140.

System 100 allows a user to access and retrieve data-objects (such as documents) from a plurality of databases. In response to a query 110, interface device 120 sends a retrieval request to the plurality of retrieval products 130. Each retrieval product in the plurality of retrieval products 130 retrieves data-objects from the database in the plurality of databases 140 to which it is coupled. For example, first retrieval product 130A retrieves data-objects from first database 140A, second retrieval product 130B retrieves data-objects from second database 140B, and so on. Each retrieval product 130 may use its own algorithm for ranking the data-objects that it retrieves. Each retrieval product 130 then sends the top M ranked data-objects to interface device 120, wherein M is an integer. Alternatively, each retrieval product may send data objects to interface device 120 when those data objects exceed some threshold of relevance with respect to the query.

In accordance with an embodiment of the present invention, the data-objects received by interface device 120 are ranked in a uniform manner before being presented to a user. To rank the data-objects in a uniform manner, each data-object received by interface device 120 is represented in a conceptual representation space. Then, the data-objects are ranked in a uniform manner based a similarity among the representations of the data-objects. In an embodiment described in Section II, the data-objects retrieved from the plurality of databases are of a single type. In this embodiment, the data-objects may be, for example, documents. In another embodiment described in Section III, the data-objects retrieved from the plurality of databases are of differing types. In this latter embodiment, data-objects may represent, for example, relational data.

In an embodiment of the present invention, the conceptual representation space may be a latent semantic indexing (LSI) space, as described, for example, in U.S. Pat. No. 4,839,853 (“the '853 patent”), the entirety of which is incorporated by reference herein. The description of the conceptual representation space in terms of an LSI space is for illustrative purposes only, and not limitation. Based on the description contained herein, a person skilled in the relevant art(s) will understand how to implement a method for ranking a federated query using a conceptual representation space that is not an LSI space. Examples of other conceptual representation spaces that can be used in accordance with an embodiment of the present invention may include, but are not limited to, the following:
1. Probabilistic LSI (see, e.g., Hoffman, T., “Probabilistic Latent Semantic Indexing,” Proceedings of the 22^{nd} Annual SIGIR Conference, Berkeley, Calif., 1999, pp. 50-57);
2. Latent Regression Analysis (see, e.g., Marchisio, G., and Liang, J., “Experiments in Trilingual Cross-language Information Retrieval,” Proceedings, 2001 Symposium on Document Image Understanding Technology, Columbia, Md., 2001, pp. 169-178);
3. LSI Using Semi-Discrete Decomposition (see, e.g., Kolda, T., and O. Leary, D., “A Semidiscrete Matrix Decomposition for Latent Semantic Indexing Information Retrieval,” ACM Transactions on Information Systems, Volume 16, Issue 4 (October 1998), pp. 322-346); and
4. Self-Organizing Maps (see, e.g., Kohonen, T., “Self-Organizing Maps,” 3^{rd} Edition, Springer-Verlag, Berlin, 2001).
   Each of the foregoing cited references is incorporated by reference in its entirety herein.

### II. Ranking Data Objects Retrieved from a Federated Query

In accordance with an embodiment of the present invention, there is provided a method for ranking data-objects retrieved from a plurality of databases, wherein the data-objects are of a single type. The data-objects are described below as documents for illustrative purposes only, and not limitation. Other types of data-objects of a single type, which are retrieved from a federated query, may be ranked in accordance with an embodiment of the present invention, as described in more detail below. The method presented below makes use of a conceptual representation space to rank the documents. In an embodiment, the conceptual representation space may be an LSI space.

A. An Example Method for Ranking Data Objects from a Plurality of Databases in Accordance with an Embodiment of the Present Invention

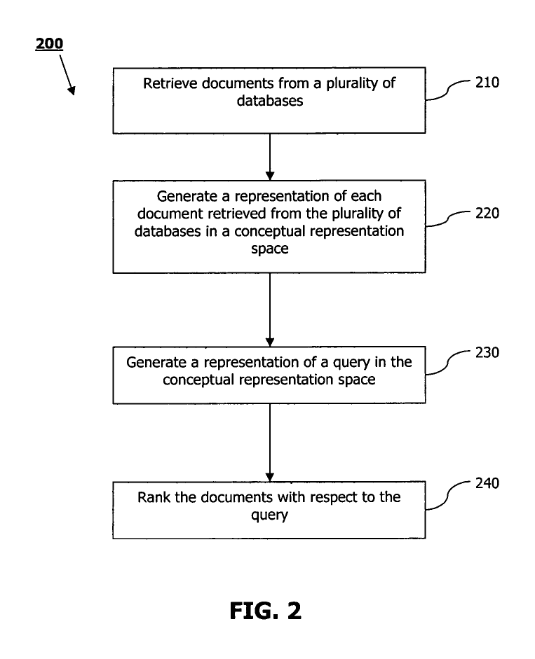

FIG. 2 depicts a flowchart of an example method 200 for ranking data objects from a plurality of databases with respect to a user query. For example, interface device 120 of FIG. 1 may implement method 200 to rank documents retrieved from the plurality of databases 140. Method 200 begins at a step 210 in which documents are retrieved from a plurality of databases, wherein each database is accessed using a retrieval product. For example, the databases may be databases 140 and the retrieval products may be retrieval products 130. Each retrieval product may be substantially identical to each other retrieval product; each retrieval product may be substantially different from each other retrieval product; or the plurality of retrieval products coupled to the plurality of databases may include a combination of substantially identical retrieval products and substantially different retrieval products.

In a step 220, a representation of each of the documents retrieved from the plurality of databases is generated in a conceptual representation space. The conceptual representation space includes a metric whereby a similarity among the representations of the documents may be measured. The representation of each document may be generated in the conceptual representation space in one of three ways, or in any combination thereof. First, the retrieved documents may be used as the sole basis for generating the conceptual representation space. For example, the retrieved documents may be used to generate an LSI space as described in more detail below in Section II.B. Second, the retrieved documents may be combined with a set of training documents, and the combined set of documents may be used to generate the conceptual representation space. For example, this second method may be used to create a more robust space when the total number of retrieved documents is relatively low. Third, the retrieved documents may be represented in a previously generated conceptual representation space. For example, the retrieved documents may be “folded” into a previously generated LSI space, as described in more detail below in Section II.C.

In a step 230, a representation of a user query is generated in the conceptual representation space. The user query may be query 110 that is used by interface device 120 to retrieve the documents from the plurality of databases 140. In the LSI-based embodiment, the user query may be represented as a pseudo-vector in the LSI space by “folding” the query into the LSI space. Folding a query into an LSI space is described in more detail below in Section II.C.

In a step 240, the documents are ranked with respect to the user query based on the similarity between the representation of the user query and the representation of the each document. For example, if the value of the similarity between the representation of the user query and the representation of a first document is greater than the value of the similarity between the representation of the user query and the representation of a second document, then the first document will be ranked higher than the second document. Ranking the documents with respect to the user query is described in more detail below in Section II.D.

In method 200, the documents retrieved from a federated query are uniformly ranked based on a conceptual similarity with the user query. As mentioned above, a conventional federated query ranks documents from a plurality of databases (e.g., plurality of databases 140) based on ranking schemes used by the various retrieval products (e.g., retrieval products 130). As a result, although a document retrieved from a conventional federated query may be highly ranked, that document may not be highly relevant to a user's query. In contrast, the similarity measure used in method 200 to rank the documents is based on a single metric (i.e., the metric defined on the conceptual representation space). Consequently, documents that are most conceptually similarity to the user query will be ranked highest. Examples of similarity measures can include, but are not limited to, a cosine measure, a dot product, an inner product, a Euclidean metric, or some other similarity measure as would be apparent to a person skilled in the relevant art(s).

B. Generating an Example Conceptual Representation Space

The second step in method 200 is to generate a conceptual representation space. The generation of a particular kind of conceptual representation space—namely, an LSI space—will now be described. However, this description is presented for illustrative purposes only, and not limitation. Other conceptual representation spaces may be used without deviating from the spirit and scope of the present invention, as mentioned above.

An LSI space represents documents, and terms contained in those documents, as vectors in an abstract mathematical vector space. To generate an LSI space, a collection of text is represented in a term-by-document matrix. For example, the documents retrieved from the plurality of databases may be represented in the term-by-document matrix. Alternatively, a collection of other documents may be used to generate the term-by-document matrix. Rows of this matrix correspond with terms, and columns of this matrix correspond with documents. Every element of the term-by-document matrix represents the frequency of occurrence of a term in a document. For example, if the fifth row corresponds with the term “patent,” and the fourth column corresponds with a document entitled “The Manual of Patent Examining Procedure” (MPEP), the element at the fifth row and fourth column of the term-by-document matrix represents the frequency of occurrence of the term “patent” in the MPEP.

The raw frequency of occurrence data in the term-by-document matrix is usually transformed into a format that is more suitable for most applications. Typically, the term-by-document matrix is transformed by applying a weighting function to each element of the matrix. The weighting function may include global weighting factors and local weighting factors. However, other weighting factors may be used as would be apparent to a person skilled in the relevant art(s). Mathematically, the transformed term-by-document matrix may be represented by a matrix Y₀.

After transforming the term-by-document matrix, the dimensionality of the transformed matrix Y₀ is reduced using a technique called singular value decomposition (SVD). A procedure for SVD is described in “Numerical Recipes,” by Press, Flannery, Teukolsky and Vetterling, 1986, Cambridge University Press, Cambridge, England, the entirety of which is incorporated by reference herein. SVD can be used to reduce any rectangular matrix of t rows and d columns (such as the transformed term-by-document matrix Y₀) into a product of three other matrices:
Y₀=T₀S₀D₀^{T} (1)
that T₀ and D₀ have unit-length orthogonal columns (i.e. T₀^{T}T₀=I; D₀^{T}D₀=I) and S₀ is diagonal. T₀ and D₀ are the matrices of left and right singular vectors that represent term data and document data, respectively. S₀ is a diagonal matrix of singular values. By convention, the diagonal elements of S₀ are ordered in decreasing magnitude.

With SVD, it is possible to devise a simple strategy for an optimal approximation to Y using smaller matrices. The k largest singular values and their associated columns in T₀ and D₀ may be kept and the remaining entries set to zero. The product of the resulting matrices is a matrix Y_{R} which is approximately equal to Y, and is of rank k. The new matrix Y_{R} is the matrix of rank k which is the closest in the least squares sense to Y. Since zeros were introduced into S₀, the representation of S₀ can be simplified by deleting the rows and columns having these zeros to obtain a new diagonal matrix S, and then deleting the corresponding columns of T₀ and D₀ to define new matrices T and D, respectively. The result is a reduced model such that
Y_{R}=TSD^{T}. (2)
The value of k is chosen for each application; it is generally such that k≦100 for collections of 1000-3000 documents.

Equation (2) mathematically represents the generation of the LSI space. The LSI space comprises the matrices T, S, and D. A document is represented in the LSI space as a row vector of the D matrix. Similarly, a term is represented in the LSI space as a row vector of the T matrix. The LSI space also includes a metric, whereby the similarity between vectors can be measured. In an embodiment, documents retrieved from the plurality of databases may be used to generate the LSI space. In an alternative embodiment, the LSI space may be generated from a collection of training documents, and then the documents retrieved from the plurality of databases can be represented in the LSI space as described, for example, in the next section.

C. Representing a Query or a Document in the Example Conceptual Representation Space

The third step of method 200 is to generate a representation of a query in the conceptual representation space. As alluded to above, a query and/or a document can be represented as a vector in the LSI space, even though the query and/or document is not among the collection of documents used to generate the term-by-document matrix. The process of representing the query or any other document in an LSI space is often referred to as “folding” the query or other document into the LSI space. For illustrative purposes, the query will be generically referred to as a “document” in what follows. The term “document” used in this section shall be broadly construed to mean either a query used to retrieve documents from a plurality of databases or a document retrieved from the plurality of databases. That is, either a query or a document retrieved from the plurality of databases can be folded into an LSI space in accordance with the technique described below. Additionally or alternatively, it is to be appreciated that the query can be among the collection of documents used to generate the term-by-document matrix.

One criterion for folding a document into an LSI space is that the insertion of a real document Yᵢ (i.e., a document that was used to generate the term-by-document matrix) should give Dᵢ when the model is ideal (i.e., Y=Y_{R}). With this constraint,
Y_{q}=TSD_{q}^{T} (3)
Multiplying both sides of equation (3) by the matrix T^{T} on the left, and noting that T^{T}T equals the identity matrix, yields,
T^{T}Y_{q}=SD_{q}^{T} (4)
Multiplying both sides of this equation by S⁻¹ and rearranging yields the following mathematical expression for folding in a document:
D_{q}=Y_{q}^{T}TS⁻¹. (5)

Thus, with appropriate rescaling of the axes, folding a document into the LSI space amounts to placing the vector representation of that document at the scaled vector sum of its corresponding term points.

As a prerequisite to folding a document into an LSI space, at least one or more of the terms in that document must already exist in the term space of the LSI space. The location of a new document that is folded into an LSI space (“the folded location”) will not necessarily be the same as the location of that document had it been used to create the term-by-document matrix (“the ideal location”). However, the greater the overlap between the set of terms contained in that document and the set of terms included in the term space of the LSI space, the more closely the folded location of the document will approximate the ideal location of the document.

A term can also be folded into an LSI space in a similar manner to folding a document into the LSI space. The basic criterion is that the insertion of a real term into Yᵢ (i.e., a term that was used to generate the term-by-document matrix) should give Tᵢ when the model is ideal (i.e., Y=Y_{R}). With this constraint,
Y_{q}=T_{q}SD^{T}. (6)
Multiplying both sides of equation (6) by the matrix D, and noting that D^{T}D equals the identity matrix, yields
Y_{q}D=T_{q}S. (7)
Multiplying both sides of equation (7) by S⁻¹ and rearranging yields the following mathematical expression for folding in a term:
T_{q}=Y_{q}DS⁻¹. (8)

Thus, with appropriate resealing of the axes, folding a term into the LSI space amounts to placing the vector representation of that term at the scaled vector sum of its corresponding document points.

As a prerequisite to folding a term into an LSI space, at least one or more of the documents using that term must already exist in the document space of the LSI space. Similar to documents, the location of a new term that is folded into an LSI space (“the folded location”) will not necessarily be the same as the location of that term had it been used in the creation of the term-by-document matrix (“the ideal location”). However, the greater the number of documents in the LSI space that use that term, the more closely the folded location of the term will approximate the ideal location of the term.

Thus, a query can be represented in a LSI space by folding the query into the LSI space using the techniques described above.

D. Ranking Documents with Respect to the Query

The fourth step in method 200 is to rank the documents with respect to the query based on a similarity between the representation of the query and the representation of each document. In the LSI example described above, the similarity is determined by comparing the vector representation of the query with the vector representation of each document. The comparison of vectors in an LSI space will now be described in more detail.

Typical comparisons between two vectors in an LSI space involve a dot product, cosine measure, or other comparison between points or vectors in the space. Additionally or alternatively, the comparison may be between vectors that are scaled by a function of the singular values of S. For example, if q corresponds to the vector representation of the query and d₁ corresponds to the vector representation of a document, then the similarity between the query vector and the document vectors (and, consequently, the similarity between the query and the document) can be computed as any of: (i) q·d₁, a simple dot product; (ii) (q·d₁)/(∥q∥×∥d₁∥), a simple cosine; (iii) (qS)·(d₁S), a scaled dot product; and (iv) (qS·d₁S)/(∥qS∥×∥d₁S∥), a scaled cosine.

Mathematically, the similarity between representation q and representation d₁ can be represented as [symbol] q|d₁ [symbol] . Then, for example, if the simple cosine from item (ii) above is used to compute the similarity between the query vector and the document vector, then [symbol] q|d₁ [symbol] can be represented in the following well-known manner:

$$〈 q \vert {d}_{1} 〉 = \frac{q \cdot d}{‖ q ‖ ‖ {d}_{1} ‖} = \frac{1}{‖ q ‖ ‖ {d}_{1} ‖} [ {\sum }_{i = 1}^{k} {q}_{i} \cdot {d}_{1 , i} ] , \qquad ( 9 )$$

where qᵢ and d_{1,i} are the components of the representations q and d₁, respectively.

Based on the similarity comparisons described above, the documents can be ranked with respect to the query. For example, the greater the similarity between a document and the query, as measured by equation (9), the higher the document will be ranked.

### III. Ranking Other Types of Data-Objects Retrieved from a Federated Query

In accordance with another embodiment of the present invention, there is provided an example method for ranking data-objects retrieved from multiple databases, wherein the data-objects are of different types. First, this example method will be motivated by discussing an embodiment pertaining to relational data. Then, such a method for ranking data-objects will be described.

A. A Motivating Example Pertaining to Relational Data

Historically, the LSI technique has been applied to unstructured data, primarily text. However, a cross-lingual LSI technique (described, for example, in the aforementioned '109 patent) can be applied to structured data (such as relational data) to generate a single representation space comprising the structured data. Using this single representation space, structured data retrieved from a federated query can be ranked in accordance with an embodiment of the present invention.

Generating a cross-lingual representation space is similar to generating an ordinary conceptual representation space. In the ordinary LSI technique, the LSI space is generated based on a collection of documents, as described above. A cross-lingual LSI space is generated in the same manner, except the collection of documents used to generate the cross-lingual LSI space comprises a parallel corpus of documents. A parallel corpus of documents includes documents from a first human language and documents from a second human language arranged as pairs, wherein each first-language document in each pair is the translation equivalent of the second-language document of the pair.

An analog to the cross-lingual LSI technique can be used to rank results retrieved from a plurality relational databases. A relational database might contain rows that have a form such as:

| | | Quantity | | |
|---|---|---|---|---|
| Purchaser | Item | (lbs) | Seller | Date |
| ABC | Ammonium | 500 | XYZ | 20 Jun. |
| Company | Nitrate | | Company | 2003 |

Such a row can be extracted as a block of text. For example, in a simple fashion it can be extracted as: ABC Company Ammonium Nitrate 500 XYZ Company 20 Jun. 2003. In a more expressive fashion, the column titles (reflecting the data definition) can be combined with the row entries to form: Purchaser ABC Company Item Ammonium Nitrate Quantity (lbs) 500 Seller XYZ Company Date 20 Jun. 2003. These small text items can be treated in the same fashion as any other block of text in creating or populating an LSI space. Experiments have shown that LSI can deal effectively with passages of text as short as sentences.

Extracting data from relational databases and indexing it in an LSI space allows a level of meta-analysis. For example, the characteristics of the LSI space can be applied in an approach to identifying candidate aliases for individuals. An analogous procedure can be applied to data extracted from relational databases and indexed into an LSI space. Such a procedure can have applications in fraud detection. In a similar manner, taxonomy generation capabilities of some LSI-based software (e.g., a taxonomy generation as described in commonly-owned U.S. Patent Application No. 60/681,945, entitled “Latent Semantic Taxonomy Generation,” filed May 18, 2005, the entirety of which is incorporated by reference herein) can be applied to identify association patterns in the relational data. Such meta-analysis can be difficult to carry out through combinations of operations within the Relational Database Management System (RDBMS) structure. Thus, simply transforming data from a relational to a conceptual representation has substantial value.

B. An Example Method for Ranking Data-Objects of Differing Types from a Plurality of Databases in Accordance with an Embodiment of the Present Invention

In addition to relational data, other types of data from a plurality of databases can be combined into a single conceptual representation space, and then ranked in accordance with an embodiment of the present invention. The LSI technique, for example, can be used to treat any combination of events and observables or objects and feature vectors. The logical equivalents of terms (observables or feature vectors) can be directly combined into a term-by-document matrix used in a standard LSI application. In this case, non-text items can be treated in an analogous fashion to foreign language items of a cross-lingual application of LSI. The idea presented above for ranking results from federated queries can be applied in this manner to results from searches of databases of relational data or databases of different data-objects, such as image data, audio data, video data, measurement data, or some other form of data as would be apparent to a person skilled in the relevant art(s).

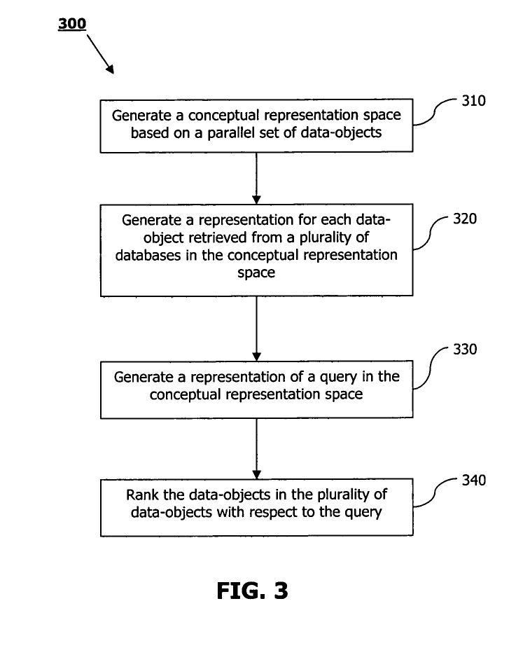

FIG. 3 depicts a flowchart illustrating an example method 300 for ranking data-objects of differing types from a plurality of databases. In general, many organizations treat such data-objects as quite distinct entities, using completely separate tools for each. Combining different types of data-objects into a single database can allow analysis across data-objects of differing types.

Example method 300 begins at a step 310 in which a conceptual representation space is generated based on a parallel set of data-objects. A parallel set of data-objects is analogous to a parallel corpus of documents. That is, the parallel set of data-objects includes at least two different types of data-objects—e.g., a first collection of data-objects of a first data type and a second collection of data-objects of a second data type. The first data type of data-objects may be, for example, text files and the second data type of data-object may be video files. Each data-object in the first collection of data-objects corresponds to a data-object in the second collection of data-objects. Using the example from above, each text file may be a title of a video file. Because the parallel set of data-objects is analogous to a parallel corpus of documents, generating the conceptual representation space in step 310 may be achieved in a manner similar to generating a cross-lingual LSI space, described above and in the aforementioned '109 patent.

In a step 320, data-objects retrieved from a plurality of databases are represented in the conceptual representation space, wherein the data-objects are either of the first data type or of the second data type. For example, the conceptual representation space can be an LSI space, and the data-objects can be folded into the LSI space in a manner similar to that described above.

In a step 330, a query is represented in the conceptual representation space. The query is represented in the conceptual representation space in a similar manner to step 220 of FIG. 2. For example, the query can be represented as a vector in an LSI space by folding the query into the LSI space.

In a step 340, the data-objects retrieved from the plurality of databases are ranked with respect to the query. For example, these data-objects may be ranked in a similar manner to step 230 of FIG. 2.

Example method 300 has several example advantages compared to other methods for ranking results from a federated query. For example, data can be drawn from databases without requiring any knowledge of the underlying data definitions. Thus, multiple sources of data can be combined readily. Moreover, the full range of analytic tools developed for textual data can be brought to bear on analysis of data of a different type, for example, relational data.

### IV. Example Computer System Implementation

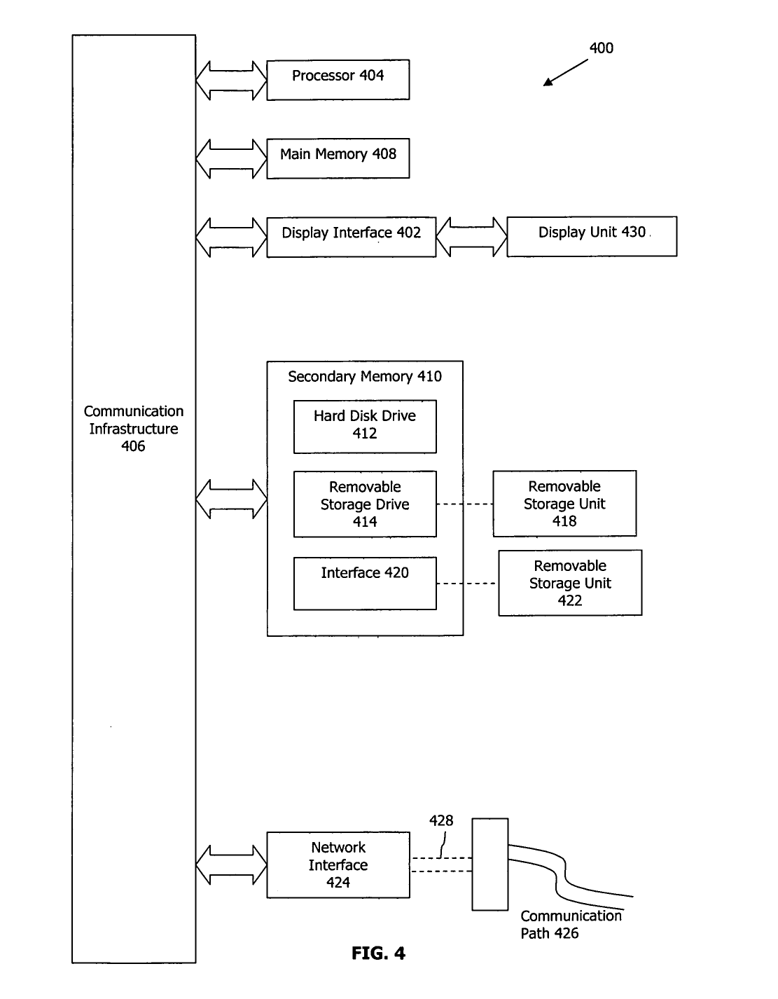

Several aspects of the present invention can be implemented by software, firmware, hardware, or a combination thereof. FIG. 4 illustrates an example computer system 400 in which an embodiment of the present invention, or portions thereof, can be implemented as computer-readable code. For example, methods 200 and 300 illustrated by the flowcharts of FIGS. 2 and 3, respectively, can be implemented in system 400. Various embodiments of the invention are described in terms of this example computer system 400. After reading this description, it will become apparent to a person skilled in the relevant art how to implement the invention using other computer systems and/or computer architectures and/or combinations of other computer systems.

Computer system 400 includes one or more processors, such as processor 404. Processor 404 can be a special purpose or a general purpose processor. Processor 404 is connected to a communication infrastructure 406 (for example, a bus or network).

Computer system 400 can include a display interface 402 that forwards graphics, text, and other data from the communication infrastructure 406 (or from a frame buffer not shown) for display on a display unit 430, such as a cathode ray tube (CRT) display, liquid crystal display (LCD) panel, projection display device, or some other display unit as would be apparent to a person skilled in the relevant art(s).

Computer system 400 also includes a main memory 408, preferably random access memory (RAM), and may also include a secondary memory 410. Secondary memory 410 may include, for example, a hard disk drive 412 and/or a removable storage drive 414. Removable storage drive 414 may comprise a floppy disk drive, a magnetic tape drive, an optical disk drive, a flash memory, or the like. The removable storage drive 414 reads from and/or writes to a removable storage unit 418 in a well known manner. Removable storage unit 418 may comprise a floppy disk, magnetic tape, optical disk, etc. which is read by and written to by removable storage drive 414. As will be appreciated by persons skilled in the relevant art(s), removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 are in the form of signals 428 which may be electronic, electromagnetic, optical, or other signals capable of being received by communications interface 424. These signals 428 are provided to communications interface 424 via a communications path 426. Communications path 426 carries signals 428 and may be implemented using wire or cable, fiber optics, a phone line, a cellular phone link, an RF link or other communications channels.

In this document, the terms “computer program medium” and “computer usable medium” are used to generally refer to media such as removable storage unit 418, removable storage unit 422, a hard disk installed in hard disk drive 412, and signals 428. Computer program medium and computer usable medium can also refer to memories, such as main memory 408 and secondary memory 410, which can be memory semiconductors (e.g. DRAMs, etc.). These computer program products are means for providing software to computer system 400.

Computer programs (also called computer control logic) are stored in main memory 408 and/or secondary memory 410. Computer programs may also be received via communications interface 424. Such computer programs, when executed, enable computer system 400 to implement the present invention as discussed herein. In particular, the computer programs, when executed, enable processor 404 to implement the processes of the present invention, such as the steps in methods 200 and 300 illustrated by the flowcharts of FIGS. 2 and 3, respectively, discussed above. Accordingly, such computer programs represent controllers of the computer system 400. Where the invention is implemented using software, the software may be stored in a computer program product and loaded into computer system 400 using removable storage drive 414, interface 420, hard drive 412 or communications interface 424.

The invention is also directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### V. Example Capabilities and Applications

The embodiments of the present invention described herein have many capabilities and applications. The following example capabilities and applications are described below: monitoring capabilities; categorization capabilities; output, display and/or deliverable capabilities; and applications in specific industries or technologies. These examples are presented by way of illustration, and not limitation. Other capabilities and applications, as would be apparent to a person having ordinary skill in the relevant art(s) from the description contained herein, are contemplated within the scope and spirit of the present invention.

MONITORING CAPABILITIES. Embodiments of the present invention can be used to monitor different media outlets having a plurality of databases and to rank results received from the plurality of databases. By way of illustration, and not limitation, the results may be related to a particular brand of a good, a competitor's product, a competitor's use of a registered trademark, a technical development, a security issue or issues, and/or other results either tangible or intangible that may be of interest. The types of media outlets that can be monitored can include, but are not limited to, email, chat rooms, blogs, web-feeds, websites, magazines, newspapers, and other forms of media in which information is displayed, printed, published, posted and/or periodically updated.

Information gleaned from monitoring the media outlets can be used in several different ways. For instance, the information can be used to determine popular sentiment regarding a past or future event. As an example, media outlets could be monitored to track popular sentiment about a political issue. This information could be used, for example, to plan an election campaign strategy.

CATEGORIZATION CAPABILITIES. A ranking of results retrieved from a federated query in accordance with an embodiment of the present invention can also be used to generate a categorization of the results. Example applications in which embodiments of the present invention can be coupled with categorization capabilities can include, but are not limited to, employee recruitment (for example, by matching resumes to job descriptions), customer relationship management (for example, by characterizing customer inputs and/or monitoring history), call center applications (for example, by working for the IRS to help people find tax publications that answer their questions), opinion research (for example, by categorizing answers to open-ended survey questions), dating services (for example, by matching potential couples according to a set of criteria), and similar categorization-type applications.

OUTPUT, DISPLAY AND/OR DELIVERABLE CAPABILITIES. A ranking of results retrieved from a federated query in accordance with an embodiment of the present invention can be output, displayed and/or delivered in many different manners. Example outputs, displays and/or deliverable capabilities can include, but are not limited to, an alert (which could be emailed to a user), a map (which could be color coordinated), an unordered list, an ordinal list, a cardinal list, cross-lingual outputs, and/or other types of output as would be apparent to a person having ordinary skill in the relevant art(s) from reading the description contained herein.

APPLICATIONS IN TECHNOLOGY, INTELLECTUAL PROPERTY AND PHARMACEUTICALS INDUSTRIES. A ranking of results retrieved from a federated query described herein can be used in several different industries, such as the Technology, Intellectual Property (IP) and Pharmaceuticals industries. Example applications of embodiments of the present invention can include, but are not limited to, ranking of prior art searches, patent/application alerting, research management (for example, by identifying patents and/or papers that are most relevant to a research project before investing in research and development), clinical trials data analysis (for example, by analyzing large amount of text generated in clinical trials), and/or similar types of industry applications.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

In addition, it is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A method for ranking data-objects retrieved from a plurality of databases, comprising:
(a) retrieving the data-objects from a plurality of databases, wherein each database is accessed using a retrieval product;
(b) generating a representation of each of the data-objects retrieved from the plurality of databases in a conceptual representation space;
(c) generating a representation of a query in the conceptual representation space; and
(d) ranking the data-objects with respect to the query based on a similarity between the representation of each data-object and the representation of the query.

2. The method of claim 1, wherein step (b) comprises:
generating a representation of each of the data-objects retrieved from the plurality of databases in a Latent Semantic Indexing (LSI) space.

3. The method of claim 1, wherein step (d) comprises:
ranking the data-objects with respect to the query based on a cosine measure between the representation of each data-object and the representation of the query.

4. The method of claim 1, wherein step (b) comprises:
generating a representation of each of the data-objects retrieved from the plurality of databases in a conceptual representation space, wherein the data-objects comprise at least one of text data, relational data, image data, audio data, video data, or measurement data.

5. The method of claim 1, further comprising:
(e) presenting the ranking from step (d) to a user.

6. A method for ranking data-objects retrieved from a plurality of databases, comprising:
(a) generating a conceptual representation space based on a first plurality of data-objects and a second plurality of data-objects, wherein the first plurality of data-objects comprises data-objects of a first data type and the second plurality of data-objects comprises data-objects of a second data type, and wherein each data-object in the first plurality of data-objects corresponds to a data-object in the second plurality of data-objects;
(b) retrieving a third plurality of data-objects, wherein each data-object in the third plurality of data-objects comprises a data-object of the first data type or a data-object of the second data type;
(c) generating a representation of each data-object in the third plurality of data-objects in the conceptual representation space;
(d) generating a representation of a query in the conceptual representation space; and
(e) ranking the data-objects in the third plurality of data-objects with respect to the query based on a similarity between the representation of the query and the representation of each data-object in the third plurality of data-objects.

7. The method of claim 6, wherein step (a) comprises:
generating a Latent Semantic Indexing (LSI) space.

8. The method of claim 6, wherein step (e) comprises:
ranking the data-objects in the third plurality of data-objects with respect to the query based on a cosine measure between the representation of the query and the representation of each data-object in the third plurality of data-objects.

9. The method of claim 6, wherein step (a) comprises:
generating a conceptual representation space based on a first plurality of data-objects and a second plurality of data-objects, wherein the first plurality of data-objects comprises data-objects of a first data type and the second plurality of data-objects comprises data-objects of a second data type, wherein each data-object in the first plurality of data-objects corresponds to a data-object in the second plurality of data-objects, and wherein the first data type and the second data type comprise at least one of text data, relational data, image data, audio data, video data, or measurement data.

10. The method of claim 6, further comprising:
(f) presenting the ranking from step (e) to a user.

11. A computer program product comprising a computer usable medium having computer readable program code stored therein that causes an application program for ranking data-objects retrieved from a plurality of databases to execute on an operating system of a computer, the computer readable program code comprising:
computer readable first program code that causes the computer to retrieve the data-objects from a plurality of databases, wherein each database is accessed using a retrieval product;
computer readable second program code that causes the computer to generate a representation of each of the data-objects retrieved from the plurality of databases in a conceptual representation space;
computer readable third program code that causes the computer to generate a representation of a query in the conceptual representation space; and
computer readable fourth program code that causes the computer to rank the data-objects with respect to the query based on a similarity between the representation of each data-object and the representation of the query.

12. The computer program product of claim 11, wherein the conceptual representation space comprises a Latent Semantic Indexing (LSI) space.

13. The computer program product of claim 11, wherein the computer readable fourth program code comprises:
code that causes the computer to rank the data-objects with respect to the query based on a cosine measure between the representation of each data-object and the representation of the query.

14. The computer program product of claim 11, wherein the computer readable second program code comprises:
code that causes the computer to generate a representation of each of the data-objects retrieved from the plurality of databases in a conceptual representation space, wherein the data-objects comprise at least one of text data, relational data, image data, audio data, video data, or measurement data.

15. The computer program product of claim 11, further comprising:
computer readable fifth program code that causes the computer to display the ranking from the computer readable third program code on a display unit.

16. A computer program product comprising a computer usable medium having computer readable program code stored therein that causes an application program for ranking data-objects retrieved from a plurality of databases to execute on an operating system of a computer, the computer readable program code comprising:
computer readable first program code that causes the computer to generate a conceptual representation space based on a first plurality of data-objects and a second plurality of data-objects, wherein the first plurality of data-objects comprises data-objects of a first data type and the second plurality of data-objects comprises data-objects of a second data type, and wherein each data-object in the first plurality of data-objects corresponds to a data-object in the second plurality of data-objects;
computer readable second program code that causes the computer to retrieve a third plurality of data-objects, wherein each data-object in the third plurality of data-objects comprises a data-object of the first data type or a data-object of the second data type;
computer readable third program code that causes the computer to generate a representation of each data-object in a third plurality of data-objects in the conceptual representation space;
computer readable fourth program code that causes the computer to generate a representation of a query in the conceptual representation space; and
computer readable fifth program code that causes the computer to rank the data-objects in the third plurality of data-objects with respect to the query based on a similarity between the representation of the query and the representation of each data-object in the third plurality of data-objects.

17. The computer program product of claim 16, wherein the conceptual representation space comprises a Latent Semantic Indexing (LSI) space.

18. The computer program product of claim 16, wherein the computer readable fifth program code comprises:
code that causes the computer to rank the data-objects in the third plurality of data-objects with respect to the query based on a cosine measure between the representation of the query and the representation of each data-object in the third plurality of data-objects.

19. The computer program product of claim 16, wherein the computer readable first program code comprises:
code that causes the computer to generate a conceptual representation space based on a first plurality of data-objects and a second plurality of data-objects, wherein the first plurality of data-objects comprises data-objects of a first data type and the second plurality of data-objects comprises data-objects of a second data type, wherein each data-object in the first plurality of data-objects corresponds to a data-object in the second plurality of data-objects, and wherein the first data type and the second data type comprise at least one of text data, relational data, image data, audio data, video data, or measurement data.

20. The computer program product of claim 16, further comprising:
computer readable sixth program code that causes the computer to display the ranking provided by the fifth computer readable program code.
